(19) United States
(12) Patent Application Publication
(10) Pub. No.: US 2024/0377092 A1
(43) Pub. Date: Nov. 14, 2024

(54) MULTI-FUNCTION ROOM CONTROLLER

(71) Applicant: Pass & Seymour, Inc., Syracuse, NY (US)

(72) Inventors: Pete Horton, Knoxville, TN (US); Thomas Cunningham, Victor, NY (US)

(73) Assignee: Pass & Seymour, Inc., Syracuse, NY (US)

(21) Appl. No.: 17/950,654

(22) Filed: Sep. 22, 2022

Related U.S. Application Data
(60) Provisional application No. 63/246,943, filed on Sep. 22, 2021.

(51) Int. Cl. F24F 11/65; F24F 11/56; F24F 110/10; F24F 110/50; F24F 130/40; G01S 1/04

(52) U.S. Cl. CPC F24F 11/65; F24F 11/56; G01S 1/042; F24F 2110/10; F24F 2110/50; F24F 2130/40

(57) ABSTRACT

A room controller for providing local control of conditions within a room, comprising: a housing; a controller disposed within the housing, the controller being configured to: receive a plurality of sensor inputs, each sensor input being representative of a condition within the room; determine, from at least one of the plurality of sensor inputs, whether a condition within the room fails to satisfy at least one of the plurality of room condition requirements; and upon determining that the condition within the room fails to satisfy the requirement, performing at least one of: controlling at least one connected device to take an action designed to satisfy the room condition requirement, or sending an alert to at least one device located outside of the room that the room condition fails to meet the room condition requirement.

### CROSS REFERENCE TO RELATED APPLICATIONS

The present application claims priority to and the benefit of U.S. Provisional Patent Application No. 63/246,943 filed on Sep. 22, 2021, the entirety of which is incorporated herein by reference.

### BACKGROUND OF THE INVENTION

### 1. Field of the Invention

The present invention relates to thermostats and, more specifically, to smart thermostats configured to control lighting and other connected devices within a room.

### 2. Description of the Related Art

In hospitality settings, the performance of a given room can change dramatically from one moment to the next. For example, a room can be quiet for most of the day, but be loud during the morning or evening. This could be automobile traffic noise from outside the building, or guests moving about the hotel. Identifying the noise and making recommendations for remediation must be prioritized for the comfort of the guests and financial considerations of the owner. Further, behavior of certain guests, from hosting noisy parties or slamming doors, can disrupt the experience for other guests. These kinds of disruptions can introduce a further degree of unpredictability to the needs of a given room

Additionally, the actions of guests can change the environmental conditions of a room from day to day, as different guests and activities impact the air quality of the room. Smoke, cologne, cooking, cleaning agents, and humidity impact the guest comfort in a space, and which can be measured in a smart room. In a smart room, automatic actions can be taken to reduce the impact of these environmental conditions through automatic ventilation. Further, the room can be made unrentable if the data insights indicate the conditions would impact the guest experience. As a hotel, or other hospitality environment, can feature hundreds, even thousands, of rooms, addressing the needs of each room presents a problem of scale that can strain the ability of guest services or housekeeping to adapt.

Such needs are not only limited to the hospitality industry. Commercial office buildings likewise feature high numbers of rooms-offices, conference rooms-whose needs can change from one moment to the next. There is a need, then, for a room controller, distributed to each room, that can address the contextual needs of a room in a variety of industries.

### BRIEF SUMMARY OF THE INVENTION

The examples described herein can be combined in any way technically possible.

According to an aspect, a room controller for providing local control of conditions within a room, includes: a housing; a controller disposed within the housing, and comprising at least one non-transitory storage medium storing program code, the program code comprising a plurality of room condition requirements, the controller being configured to: receive a plurality of sensor inputs, each sensor input being representative of a condition within the room, each sensor input being respectively received from one of a plurality of sensors disposed locally with respect to the room controller; determine, from at least one of the plurality of sensor inputs, whether a condition within the room fails to satisfy at least one of the plurality of room condition requirements; and upon determining that the condition within the room fails to satisfy the requirement, performing at least one of: controlling at least one connected device to take an action designed to satisfy the room condition requirement, or sending an alert to at least one device located outside of the room that the room condition fails to meet the room condition requirement.

In an example, the room controller further includes a temperature sensor disposed within the housing, the temperature sensor outputting a temperature sensor signal representative of an ambient temperature within the room, wherein the room controller is further configured to control a climate control system according to a target temperature and the temperature sensor signal such that the climate control system maintains the ambient temperature substantially at the target temperature.

In an example, sending an alert to at least one device located outside of the room that the room condition fails to meet the room condition requirement occurs upon determining that controlling the at least one connected device to take the action fails to satisfy the room condition.

In an example, sending the alert to at least one device located outside the room comprising sending an alert to a hotel room management system.

In an example, one of the plurality of sensor inputs is an input from an air quality sensor representing an air quality of the room, wherein one of the plurality of room condition requirements is an air quality requirement such that the controller is configured to determine whether the air quality of the room satisfies the air quality requirement as one of the plurality of room condition requirements.

In an example, determining whether the air quality of the room satisfies the air quality requirement comprises comparing the air quality represented by the air quality input to a threshold.

In an example, for the air quality requirement, controlling at least one connected device to take an action designed to satisfy the room condition requirement comprises sending a control signal to a damper to circulate external air within the room.

In an example, for the air quality requirement, sending an alert to at least one device located outside of the room comprises sending an alert to a hotel room management system that the air quality of the room fails to satisfy the air quality requirement.

In an example, one of the plurality of sensor inputs is an input from a microphone representing an ambient noise within the room, wherein one of the plurality of room condition requirements is an ambient noise requirement such that the controller is configured to determine whether the ambient noise of the room satisfies the ambient noise requirement as one of the plurality of room condition requirements.

In an example, determining whether the ambient noise of the room satisfies the ambient noise requirement comprises comparing the ambient noise represented by the microphone input to a threshold.

In an example, determining whether the ambient noise of the room satisfies the ambient noise requirement comprises comparing the ambient noise represented by the microphone to one of a plurality of stored signals to determine whether the ambient noise matches one of the stored signals.

In an example, for the ambient noise requirement, sending an alert to at least one device located outside of the room comprises sending an alert to a hotel room management system that the ambient noise fails to satisfy the ambient noise requirement.

In an example, the controller is further configured to provide a beacon signal, via the antenna, such that a nearby antenna-equipped device can locate itself relative to the beacon signal.

According to another aspect, a room controller for controlling multiple functions within a room, includes: a temperature sensor outputting a temperature sensor signal representative of an ambient temperature within the room; and a controller configured to control a climate control system according to a target temperature and the temperature sensor signal such that the climate control system maintains the ambient temperature substantially at the target temperature, wherein the controller is further configured, according to whether a user is detected within the room, to adjust the target temperature and to direct, via a control signal, at least one device within the room to enter a first state or a second state, such that: when a user is not detected, the controller sets the target temperature to a first value and directs the at least one device within the room to enter the first state, and when a user is detected, the controller sets the target temperature to a second value and directs the at least one device within the room to enter the second state, wherein, the first value is selected such that climate control system consumes less energy maintaining the ambient temperature substantially at the target temperature than at the second value, wherein the at least one device consumes less energy in the first state than in the second state.

In an example, the climate control system is directed according to a climate control signal output from a climate control output terminal

In an example, the room controller further includes an antenna; wherein the at least one device is directed to enter the first state or the second state according to one or more control signals sent via the antenna.

In an example, the at least one device includes a lamp, wherein in the first state the lamp produces less illumination than in the second state.

In an example, the one or more control signals are set to a plugload terminal or to a switch controlling the illuminance of the lamp.

In an example, the one or more control signal is sent to the lamp.

In an example, the controller receives a motion signal from a motion detector, wherein the user is detected if the motion signal represents detecting motion of the user within the room, wherein a user is not detected within the room if, at least, the motion signal represents no detected motion for more than a predetermined length of time.

In an example, the controller further receives a door signal from a door sensor, wherein the user is not detected if, at least, the door signal represents that the door has opened and the motion signal represents no detected motion for more than the predetermined length of time.

In an example, the room controller further includes an air quality sensor, wherein the room controller is configured to adjust a damper to circulate external air within the room if the air quality is detected as falling below a predetermined threshold.

In an example, the room controller further includes a microphone outputting a microphone signal, wherein the controller is further configured to send an alert signal to a user if the microphone signal matches a predetermined criterion.

In an example, the predetermined criterion is a threshold value.

In an example, the predetermined criterion is a stored signal.

### BRIEF DESCRIPTION OF THE SEVERAL VIEWS OF THE DRAWING(S)

The present invention will be more fully understood and appreciated by reading the following Detailed Description in conjunction with the accompanying drawings/

FIG. 1 depicts hotel room featuring devices controlled by a room controller, according to an example.

FIG. 2 depicts a hotel network featuring room controllers in guest rooms, according to an example.

FIG. 3 depicts a block diagram of a room controller, according to an example.

FIG. 4 depicts a room controller, according to an example.

FIG. 5 depicts a graph of screen light according to ambient light, according to an example.

FIG. 6A depicts a graphical waveform representation of the acoustical sound of an air conditioner.

FIG. 6B depicts a graphical waveform representation of the acoustical sound of a gun shot.

FIG. 7 depicts a wiring diagram of a room controller, according to an example.

FIG. 8 depicts a flowchart of a method for adjusting a room according to whether the room is occupied.

FIG. 9 depicts a flowchart of a method for monitoring an air quality requirement and taking corrective action if the air quality requirement is not satisfied.

FIG. 10 depicts a flowchart of a method for monitoring an air quality requirement and taking corrective action if the air quality requirement is not satisfied.

FIG. 11 depicts a flowchart of

### DETAILED DESCRIPTION OF THE INVENTION

Aspects of the various examples and certain features, advantages, and details thereof, are explained more fully below with reference to the non-limiting examples illustrated in the accompanying drawings. Descriptions of well-known structures are omitted so as not to unnecessarily obscure the invention in detail. It should be understood, however, that the detailed description and the specific non-limiting examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

Reference will now be made in detail to the present exemplary embodiments of the invention, examples of which are illustrated in the accompanying drawings. Wherever possible, the same reference numbers will be used throughout the drawings to refer to the same or like parts. Various parts/elements of the protective device of embodiments of the present invention are first identified below and illustrated in the accompanying drawings. Many of the parts/elements are conventional, should be understood by a person of ordinary skill in the art in conjunction with a review of this disclosure, and are not necessarily further discussed in detail beyond being identified and represented in certain Figures. The structure, configuration, and positioning with respect to other particular parts/elements/assemblies in the assembled protective wiring device as a whole, and/or functionality of other particular parts/elements/assemblies are unique and inventive. Such other parts/elements/assemblies are described in further detail below in addition to the being identified and represented in certain Figures.

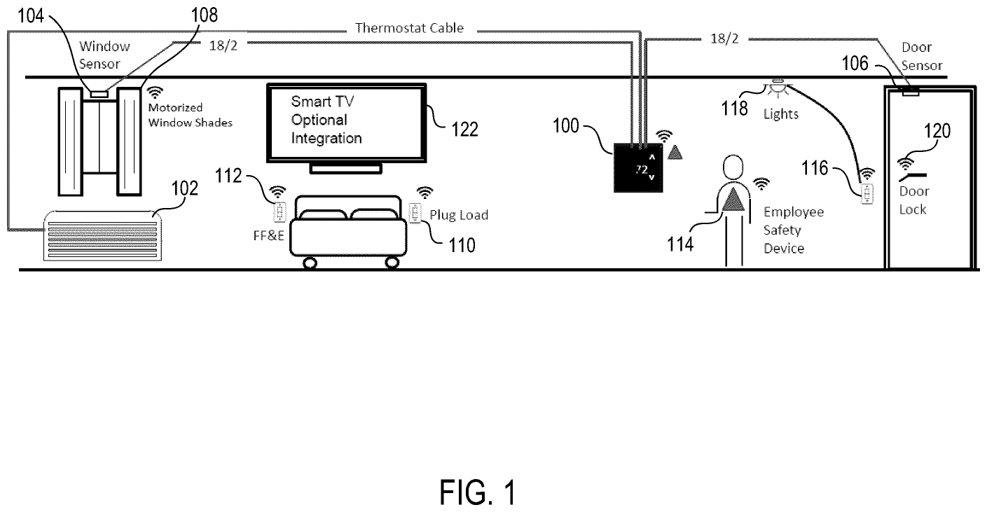

There is shown in FIG. 1, a multi-function room controller 100 featuring sensors, sensor inputs, and control outputs to a heating ventilation air conditioning system (i.e., the room controller functions as a thermostat, adjusting the temperature of the room) and one or more other devices for adapting the environment and devices in a room to varying contexts and user inputs. More particularly, FIG. 1 depicts a room controller 100 featuring wired connections to an HVAC unit 102 (e.g., packaged terminal air conditioner (PTAC), vertical terminal air conditioner (VTAC), or variable refrigerant flow (VRF)), wired sensor inputs from a window sensor 104 and a door sensor 106, and wireless connections to motorized window treatments 108, a plugload terminal 110, wireless furniture, fixtures, and equipment 112, an employee safety device 114, a smart switch 116, lights 118, a door lock 120, and a smart TV 122. At a high level, room controller 100 can function as a thermostat, measuring an ambient temperature and controlling an HVAC system (also referred to as a “climate control system”) to maintain the ambient temperature substantially at a target temperature, set by a user or set, as will be described below, according to an algorithm that takes into account the context of the room. (The basic function of a thermostat to controlling an HVAC system to maintain a room temperature substantially at a target temperature is well known and will not be discussed further in this disclosure.) Room controller 100 further interprets the inputs of various sensors to control the wired and wirelessly connected devices in a manner that adapts to the varying contexts of the room and/or user inputs. It should be understood that the kinds of devices depicted, including plug load terminal 110, motorized window treatments 108, etc., are provided as typical examples of the kinds of devices utilized in a hospitality or corporate setting. Additional devices, or different devices, including connected kitchen devices, plumbing devices, etc., can be used in various alternative examples. Further, which devices are wired or wirelessly connected to room controller 100 is only given in FIG. 1 as an example of the kinds of connections that can be made to such devices. In various alternative examples, each device can be connected with a wired or a wireless connection, according to the requirements of the device and demands of the room set up.

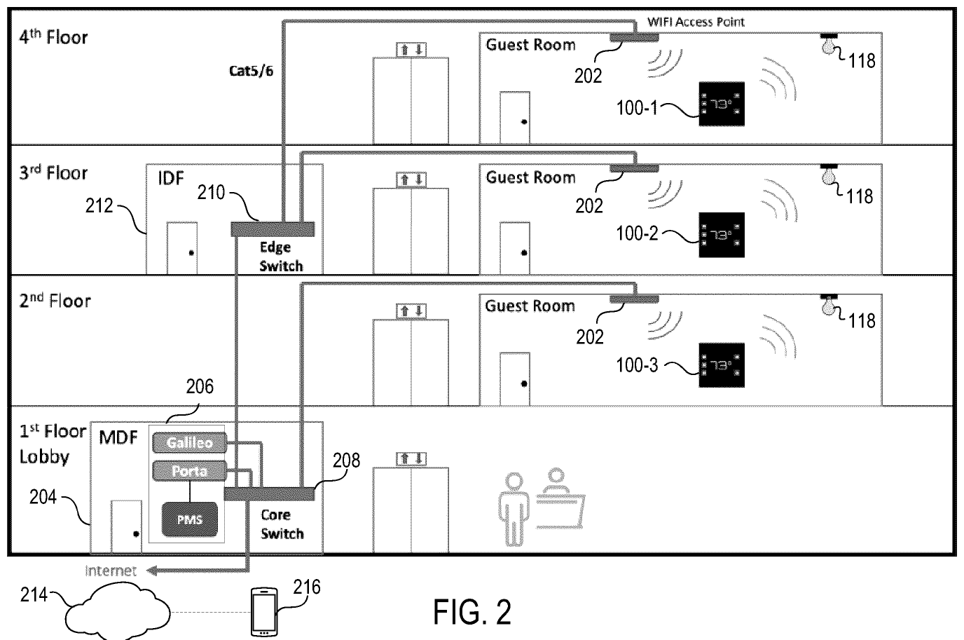

FIG. 2 depicts an example architecture of multiple room controllers 100 employed in separate rooms within a hospitality setting. As shown, each room controller 100 is wirelessly connected, through a Wi-Fi access point 202, to a main distribution frame 204 (e.g., a local server 206), from which various analytic and control software can be employed to monitor and control each room controller 100. Each room controller 100 can be further connected to the internet for receiving commands and communicating with a remote server 214 (the cloud). Room controller 100 can, in this way, receive commands from a user through an internet connection (e.g., through a browser or through a dedicated application, accessed, for example, via mobile device 216). For example, the hotel could offer a companion app in which a user could preset desired settings for the room. This will be discussed in more detail below in the context of a user presets.

As further shown in FIG. 2, room controllers 100 can be networked in various ways. For example, room controller 100 is connected via the wireless access point 100-3 directly to core switch 208 at the main distribution frame 204. By contrast, room controllers 100 and 100-1, 100-2 are connected to an edge switch 210 at an intermediate distribution frame 212 and from edge switch 210 to core switch 208. These are simply provided as examples of networking of room controllers 100 to permit the kinds of functions described in this disclosure. As will be understood, any suitable form of networking can be used to manage room controllers 100. For example, rather than using Wi-Fi access points 202, other methods of connection each room controller to the main distribution frame 204, including wired and wireless connections, can be used.

FIG. 2 is a block diagram of an example room controller 100, depicting its various basic components. As shown, room controller 100 can comprise a controller 302 (e.g., a microcontroller) including a processor 304 (e.g., a processor included in the microcontroller, although a separate processor could be used) programmed to execute various functions as stored in a non-transitory storage medium 306 and described in this disclosure. One such suitable processor can be an NXP i.MX 8M Mini, an embedded multicore applications processor for use in IoT contexts. In various alternative examples, controller 302 can include one or more processors and one or more non-transitory storage media, as well as any associated hardware, working in concert to execute the functions described in this disclosure. The components of the controller, accordingly, need not be housed within a single housing or within a single chip, but can be distributed as needed within room controller 100.

Further, as described in connection with FIGS. 1 and 2, room controller 100 can comprise a set of internal sensors 308. Examples of such sensors include sensors for detecting the environment of the room such as, temperature sensor 310, humidity sensor 312, and air quality sensor 314 (e.g., total volatile organic compounds sensor), sensors for detecting the presence of a guest, such a motion sensor 316 (e.g., passive infrared sensor) or proximity sensor 318, as well as other sensors such an ambient light sensor 320 and a microphone 322. In addition, room controller 100 include inputs 324 for receiving signals from external sensors, such as a door sensor input 326, a window sensor input 328, and an external motion sensor input 330 (i.e., a motion sensor that is disposed outside of the room controller 100, such as in an advantageous location within the room). It should be understood that the sensors described are examples of the kinds of sensors that could be employed by room controller 100 to sense the environment, motion, light, etc. Indeed, in various examples, other types of sensors can be used. Further, although sensors 310-322 are shown disposed within room controller 100, it should be understood that these sensors can be disposed outside of room controller 100, so that room controller 100 receives the input signals from such sensors as additional inputs 324.

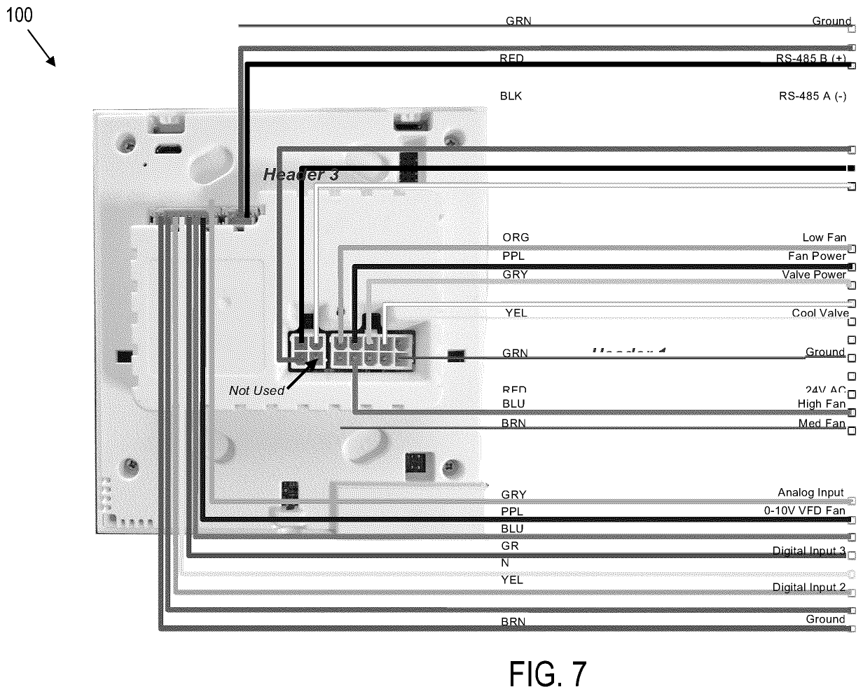

Room controller 100 can further include outputs 332 such as HVAC output 334 for controlling the HVAC system. Each output can include a relay for alternately activating or deactivating the output (as required to enable room controller 100 to be able to connect to a variety of different types of HVAC systems). Details of the various outputs are shown, in an example, in FIG. 7, described below.

Room controller 100 can further include an antenna 336 (which can include more than one antenna) for wirelessly communicating with devices, such as the IoT devices (for example, as described in connection with FIG. 1). Wireless signals can be transmitted according to any suitable wireless communications protocol, such as BACnet IP, BACnet MS/TP, Modbus, Zigbee, Matter, DMX, WiFi, Bluetooth, etc., and use additional technology such as RS-485, beacons, for transmission. Room controller 100 can thus form a constituent part of a mesh network of internet-of-things (IoT) devices, such as plugloads, smart lighting systems, door locks, wirelessly controlled motorized window shades, etc. In such an example, room controller 100 typically operates as the central device from which the IoT devices within are controlled. Accordingly, room controller 100 can be implemented as a IoT hub, such as a ZigBee gateway or a BLE Central Control device.

Additionally, as described in connection with FIG. 2 antenna 336 can be used for connection to local server or to a remote server for analytics and/or control. Such connection can be made through, for example, a WiFi access point 202, as shown in FIG. 2, though other suitable methods of making network connections (e.g. wired connections, wireless connections through other communication protocols) to local or remote servers are contemplated in this disclosure.

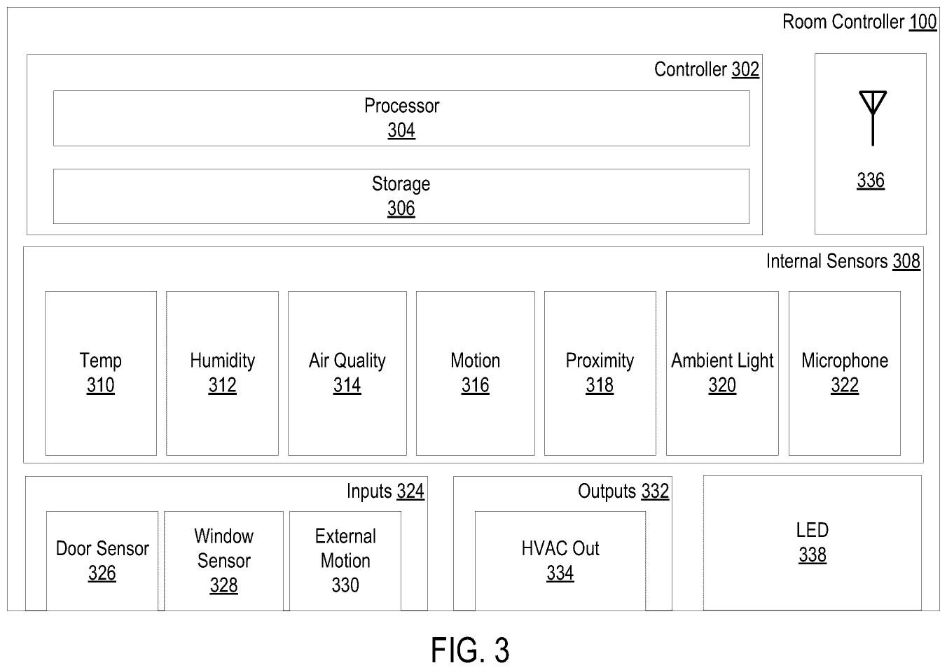

As shown in FIG. 3, room controller 100 can further include an LED 338 (which can include more than one LED) for illuminating the wall beneath room controller 100, the operation of which is described in more detail below.

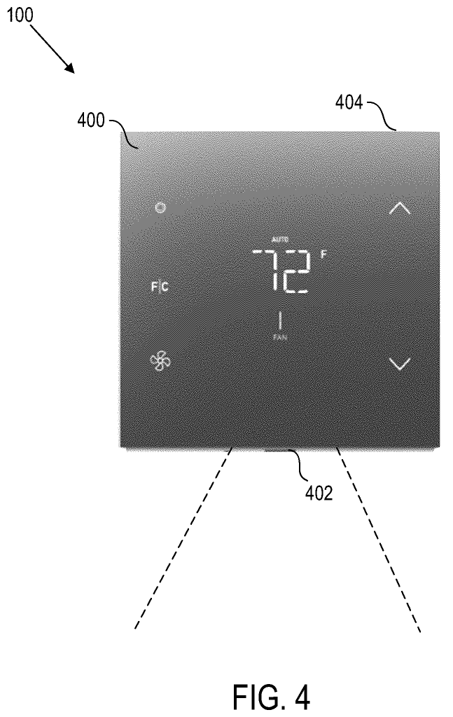

Further, as shown in FIG. 4, room controller 100 can include a screen for displaying information to a user (e.g., hotel guest or technician), such as the temperature of the room, as well as control or programming options for the connected devices. Room controller 100 can feature a touch screen, such as a capacitive touch screen (although other suitable forms of touch screens are contemplated herein) for receiving user inputs. In the example, of FIG. 400 inputs can include Power, Farenheit/Celsius selections, Fan Speed, and Temperature Control, although other physical controls are possible. Additionally, or alternative, room controller 100 can feature one more physical buttons for receiving inputs from a user. Further, the buttons shown in FIG. 4 are only one example of inputs that can be included on room controller 100. In an alternative example, room controller 100 can feature further inputs for controlling how room controller 100 should control any connected devices, such as lights (including brightness/color temperature), nightlights or pathway lighting, smart tv options, or any other devices connected to the connected plugloads.

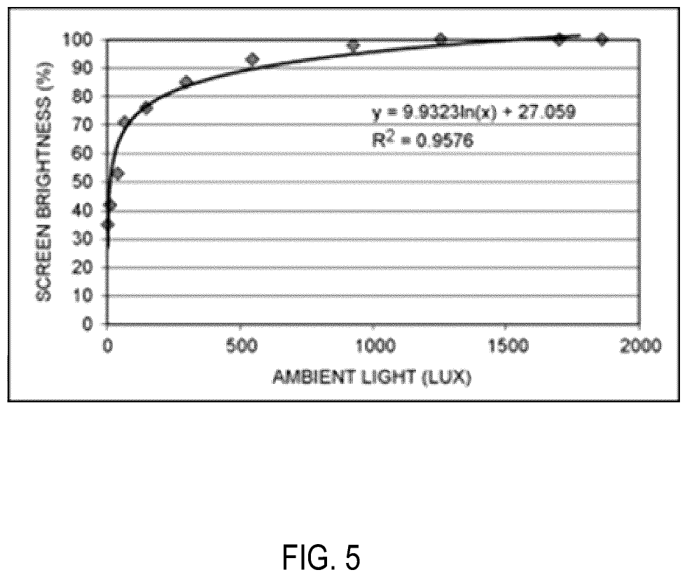

In an example, the screen brightness can be determined by the ambient light within a room, the proximity of a user to room controller, or both. For example, room controller 100 can feature sleep and wake states, in which the brightness of screen 400 can be adjusted. In one example, during sleep state, the screen can be dimmed, with, for example, only the temperature illuminated. The amount that the screen is dimmed can be determined by the ambient light sensor 320, with greater amounts of ambient light requiring less dimming for the screen to remain legible. The precise dimming value, as determined by ambient light, can be set, in an example, according to the following equation (1):

$$P = C * ln x + D \qquad ( 1 )$$

where P is the percent of maximum screen brightness, x is the luminous intensity of the ambient light as measured by the ambient light sensor 320, and both C and D are constants that can be set when room controller 100 is configured (e.g., by hotel staff). An example of equation (1) is shown in the graph of FIG. 5. The screen brightness during sleep mode is accordingly set according to the quantity of ambient light. Since room controller is in the sleep state, the brightness of the screen can be capped at some value, such as 40%.

Once the proximity sensor 318 detects a user nearby, or a button is pressed, room controller can exit the sleep mode and enter the wake mode, in which the screen brightness increases, typically to some value above 50%, i.e., a target brightness. The target brightness can be set using equation (1), but without the cap of the predetermined value. In an example, the screen can slowly change to this value over a predetermined time period (e.g., 0.5 seconds).

After a predetermined period of time without an input and without a detected user nearby, room controller 100 can resume sleep mode according to the brightness settings described above.

The ambient light sensor 320 output can be further employed to set the output value of an LED wall light. For example, when the ambient light is detected to be below a predetermined value, the wall light, LED 338, can be turned on to illuminate the wall beneath room controller (the illumination being represented by reference numeral 402). In certain examples, wall light can be turned off when the room controller is in use (i.e., the proximity sensor detects that a user is using the device or a button is pressed).

Further, ambient light sensor 320 can be employed to activate pathway lighting to avoid user trip and falls in the dark. For example, a wired or wireless command can be sent to the pathway lights to illuminate (this command can, for example, be sent to a plugload terminal, such as plugload terminal 110, or a smart switch, such as smart switch 116). In addition, the motion sensor 316 can be used to only turn on the pathway lights when a user is moving. This allows the room to stay dark when at night time, but provide necessary illuminance when a user is moving in a dark room.

Also as shown in FIG. 4, room controller 100 can further include a housing for enclosing the various components described above in connection with FIG. 3, including controller 302, internal sensors 308, inputs 324, outputs 332, antenna 336, and LED 338.

Room controller 100 can be used to perform one or more preprogrammed sequences of operations to increase the quality of stay of a hospitality guest, to optimize working conditions for a corporate environment, or to perform any other suitable function as will be described below. For example, as mentioned above, the needs of a given hotel room will vary from one moment to the next. Accordingly, room controller 100 can be preprogrammed to adjust the thermostat and the status of various other connected devices according to whether a room is occupied. When the room is in an unoccupied state, the thermostat target temperature can be set to a value that is more energy efficient than what might be normally comfortable for a guest (e.g., hotter than normal in the summer or colder than normal in the winter). Further, the window treatments can be drawn close in the summer to keep the room cooler or left open in the Winter to keep the room warmer during the day. Likewise, the lights and any other energy consuming device can be left in the OFF state.

Once the room is occupied, room controller 100 can be preprogrammed to set the room temperature to a preprogrammed value, to open the window treatments, turn ON the lights, and otherwise adjust the environment of the room to be comfortable for the guest.

Various sensor inputs can be used to determine whether the room is occupied or unoccupied at any given moment. Such sensors include door sensors 106 to detect when the door opens or closes and motion sensors 316 (or the motion sensor input 330 if an external motion sensor is used) to detect when there is motion in the room. For example, if the door is detected as opened, and the motion sensor 316 and/or motion sensor input 330 reveals no motion in the room for a predetermined period of time (e.g., 10 minutes), the room controller 100 can set the room into the unoccupied state. Once, however, the door is detected as opening and/or motion is detected in the room, the room can resume the occupied state.

Additionally, determination of whether the room is occupied or unoccupied can be determined by room controller 100 (e.g., by controller 302) or by analytics performed in a local server or in a remote server (e.g., remote server 214, shown in FIG. 2). Accordingly, the status of the room can be determined by edge analytics, i.e., by room controller 100 itself, or through cloud computing receiving the data representative of the various sensors in communication with, or included in, room controller 100.

The precise nature of the room environment and status when occupied can be configured by the user (e.g., the hotel or by a guest). For example, the hotel can set a default setting for the occupied state, which can include a default target temperature and humidity level (as sensed by temperature sensor 310 and humidity sensor 312, respectively), and a default state for the various connected devices, such as window treatments (percent open), lighting levels (dimming percentage, color temperature), smart television ON state and channel, as well as the status of any other controllable devices (e.g., furniture, fixtures, and equipment 112). (The lighting levels can be set through commands to plugload terminals 110, smart switches 116, or to smart lighting 118.) Alternatively, these values can be configured by the guest through the room controller screen 100, or, more typically, through an internet connection such as a companion application on the user's mobile device (represented in FIG. 2 as mobile device 216). The settings can then be transmitted to room controller 100 via, e.g., a switch, such as core switch 208 or edge switch 210, and through wireless access point, e.g., wireless access point 202. In this way, the user can configure a set of desired presets for the room that can be initiated once the room shifts from the unoccupied to the occupied state.

When the room is in the unoccupied state, the target temperature and humidity levels, as well as the status of the controlled devices can revert to the energy efficient state. As mentioned above, what is energy efficient can vary according to the time of year, but it can also be adjusted according to the more precise reading of current weather (including temperature) and the rental rates of the rooms, with rooms that are rented less frequently permitted to remain either colder or hotter than typical, since the temperature needs to be adjusted less frequently to accommodate guests.

At a high level, room controller monitors input signals from local sensors (which include sensors disposed locally within the room as well as room controller itself) to determine whether a corrective action, including controlling a connected device or alerting a remoted device, should be taken. Stated differently, the room controller (specifically, the controller 302 internal to room controller 100) implements a rule engine to determine whether one or more room condition requirements, e.g., air quality or ambient noise, are satisfied. If, based upon the input signals from one or more sensors, such rules signifying one or more condition requirements are not satisfied, the corrective action can take place. In this way, the room controller performs edge analysis to address the ongoing needs of a room and to communicate with outside systems of instances in which the room condition has deteriorated below an acceptable level.

For example, as described in connection with FIG. 3, room controller 100 can include an air quality sensor 314 (e.g., atVOC and/or CO₂eq sensor). If the HVAC system includes a damper for circulating outside air, damper can be actuated, via the HVAC output 334, in response to air quality falling below a predetermined threshold. For example, if the measured volatile organic compounds or the equivalent greenhouse gases measured by the air quality sensor(s) exceeds a predetermined threshold, the damper can be actuated to introduce more external air before guests complain about the air quality. Alternatively, or additionally, an air purifier (including, e.g., a HEPA air filter) can be turned on or the fan speed increased, to address an air quality problem.

Alternatively, or additionally, a device outside the room, such as a main distribution frame or a remote service, and including, in some instances, a hotel room management system, can be alerted if the air quality requirement is not met. In some examples, the alert can take place after the damper has been actuated and/or the air purifier adjusted, and if such measures have failed to address the air quality problem. Alerting the outside device can result in alerting hotel staff of the air quality problem and/or automatically removing the room from a reservable status.

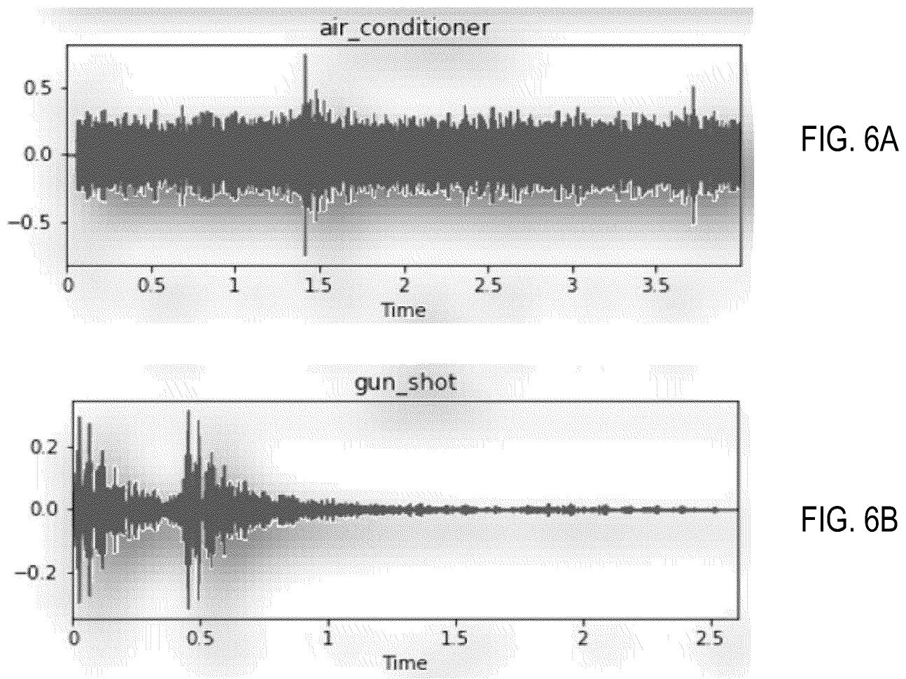

Additionally, ambient noise, as can be measured by microphone 221. If ambient noise (e.g., measured decibels), exceeds some predetermined threshold, an outside device can be alerted of the disturbance and notify hotel staff to investigate before guests complain. Indeed, more advanced processing can be performed on the ambient noise to distinguish between noise that originates from acceptable sources of noise, such as the sounds of air conditioner (the microphone signal of which is depicted in FIG. 6A) and the sounds of gun shots (the microphone signal of which is depicted in FIG. 6B). Indeed, a variety of sounds, such as slamming doors, loud music, gun shots, etcs., can be stored in memory and compared against the microphone input to determine if hotel staff or emergency services should be notified. If such a signal is detected, the notification can, for example, proceed from room controller 100 to local server 206, which can push an alert to the front desk or other location.

Additionally, input from various sensors can be analyzed by controller 302, or relayed to local processing (e.g., a local server) or remote processing (e.g., a remote server) for analytics to compare individual and benchmarking room performance. The evaluated data or conclusions are considered insight, which can be related to room comfort, energy consumption, guest experience, or operational performance. Such benchmarking and comparison can be used for recommending remedial actions or insights, which can be provided, for example, to a front desk or other staff for determining changes that can be made to increase comfort or performance of the room.

Room controller 100 can further include a radio frequency beacon, such as a Bluetooth beacon, for providing indoor navigation and geolocation positioning. In other words, an antenna equipped device can determine relative location to the beacon. Such beacons can be used, for example, to locate the position of an employee activating an employee safety device (e.g., employee safety device 120, shown in FIG. 1). It can also be used to provide navigation for guests attempting to locate their room, or navigate to locations within the building, such as pool, gym, or conference room, using, for example, the guest's mobile device (e.g., mobile device 216, shown in FIG. 2). If multiple room controllers equipped with beacons are dispersed throughout a building, various controllers, acting as beacons, can together be used for such navigation or geolocation, e.g., through triangulation.

For the sake of completeness, an example wiring diagram is provided in FIG. 7, providing for connections to various types of HVAC systems, including four separate wiring harnesses to access specific features. These wiring harnesses provide examples of the HVAC out 334. As shown, wiring harness 1, the main harness, features the following pin mapping:

TABLE 1

| Pin Number | Function | Color |
|---|---|---|
| 1 | Ground | Green |
| 2 | 24 VAC | Red |
| 3 | Common | Black |
| 4 | High Fan | Blue |
| 5 | Medium Fan or Second Stage Heat | Brown |
| 6 | Cold Water Valve or Compressor | Yellow |
| | Signal (Heat Pump) | |
| 7 | Hot Water Valve or Reversing | White |
| | Valve (Heat Pump) | |
| 8 | Valve Power | Grey |
| 9 | Fan Power | Violet |
| 10 | Low Fan | Orange |

Wiring harness 2, a digital wiring harness, features the following pin mapping:

TABLE 2

| Pin Number | Function | Color |
|---|---|---|
| 1 | Analog Input - Remote Thermistor | Grey |
| 2 | Analog Output - 0-10 V VFD Fan | Purple |
| 3 | Digital Input 3 - External PIR/motion sensor | Blue |
| 4 | Digital Input 2 - Balcony Door/Window, | Green |
| | 2 transitions to active | |
| 5 | Digital Input 1 - Entry Door, 2 transitions | Yellow |
| | to active | |
| 6 | Not Used | Orange |
| 7 | VEE (12 Vdc) | Red |
| 8 | GND Ground | Brown |

Wiring harness 3, an RS485 harness, features the following pin mapping:

TABLE 3

| Pin Number | Function | Color |
|---|---|---|
| 1 | RS-485 A (−) | Black |
| 2 | RS-485 B (+) | Red |
| 3 | GND | Green |

Wiring harness 4, a damper harness, features the following pin mapping:

TABLE 4

| Pin Number | Function | Color |
|---|---|---|
| 1 | Reserved no connection | N/A |
| 2 | TER Dam R 24 VAC | Red |
| 3 | TER Dam No Normally Open | White |
| 4 | TER Dam No Normally Closed | Black |

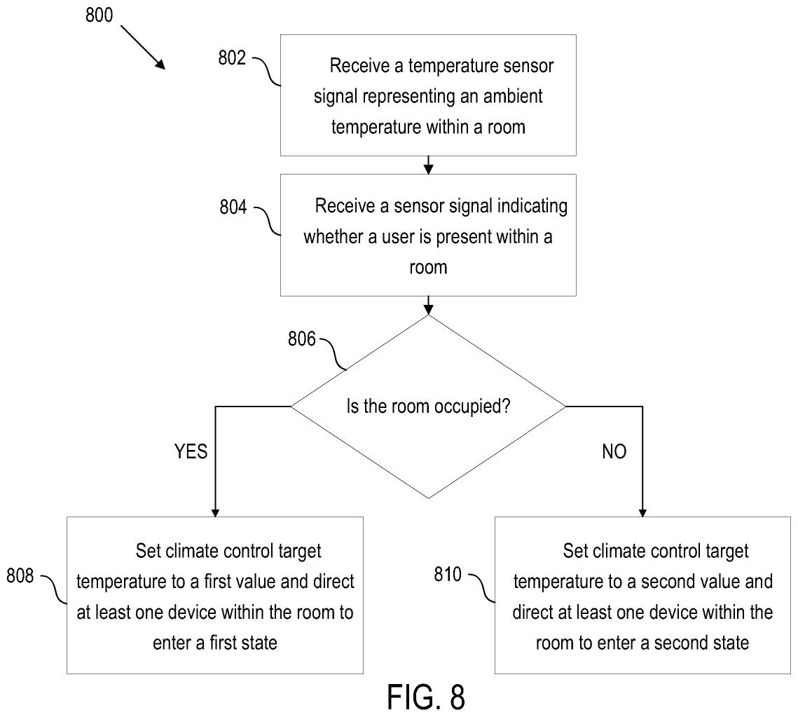

FIGS. 8-10 depict various method that can be performed, in an example, by a room controller such as room controller 100. Some or all the steps of method 800 can be performed by one or more processors, and any associated hardware, according to steps stored in one or more non-transitory storage media. However, in certain examples, certain steps can be performed by one or more processors located remote from room controller, such as at a remote server or by a local server. In various examples, a room controller can perform all of the methods described in FIGS. 8-12, however, it is conceivable that various room controllers could be programmed to perform one of or some combination of the methods described below.

FIG. 8 depicts a flowchart of a method 800 for adjusting a room according to whether the room is occupied. At step 802, a temperature sensor signal representing an ambient temperature within a room is received. In an example, the temperature sensor signal can be received from a temperature sensor disposed within the room controller (i.e., within the housing of room controller), or, alternatively, it can be disposed outside of the room controller, such as within a self-contained standalone unit.

At step 804, a sensor signal indicating whether a user is present within a room is received. The signal can be received from any of various sensors suitable for detecting whether a user is present in a room, including, for example, a motion sensor, a proximity sensor, or a door sensor, or some combination of these sensors. Where multiple sensors are used to detect whether a room is occupied, multiple sensor signals can be received at step 804.

As appropriate, such sensors can be disposed within room controller or outside of room controller. For example, while motion sensor and proximity sensor can be disposed within room controller, it is typically necessary for door sensor to be located at the door to detect when it opens or closes. It is conceivable, however, that all of the sensors, or none of the sensors, used to detect whether a room is occupied are disposed within the room controller.

At step 806, the input signals from the sensor(s) described in step 804 are used to determine whether the room is occupied. This step entails comparing the input sensor signal(s) to a predetermined criterion to determine whether the room is occupied. In one example, if a door open event is detected by a door sensor and, after this event, no user motion is detected, by one or more motion sensors, within the room for a predetermined period of time (e.g., 10 minutes), it can be determined that the user has left the room and the room is unoccupied. Other sensor signals and other criterion for determining when the room is unoccupied are contemplated herein. In various examples, step 806 can be performed by room controller 100 or can be performed by a processor located from the room controller, such a local server or a remote server.

At step 808, if the room is determined to be occupied, the climate control system target temperature is set to a first value and at least one device within the room is directed to enter a first state. The first value is set to a value that is comfortable for the user. This can be a default value (e.g., set by a hotel or by the manufacturer) or can be set by a user. The first value can be set locally (e.g., through a display and control input at the room controller) or remotely (e.g., from a remote server). In one example, the user can set the occupied room temperature via an internet connection (e.g., through a browser or through a companion mobile application). Thus, if a user prefers that, while the room is occupied, the room temperature be set to 72 degrees, this can be set through a mobile application. Once the room is detected to be occupied, the room controller can automatically set the target temperature to 72 degrees. Typically, the target temperature is set through a connection to an HVAC system, such as through an HVAC cable connected to an air conditioning system. It is conceivable, however, that this function could be performed wirelessly, if current or future HVAC systems include processors that can be controlled with wireless signals. As part of the control of the HVAC system, the humidity of the room can also be controlled to assume a value for an occupied room, as set by a user (e.g., hotel or guest or as a default value).

At step 808, at least one other device is further directed to enter a first state. In one example, the at least one device is lighting within the room. For example, once the room is occupied, the room controller can instruct, wirelessly, the lights within the room to turn on. This can be accomplished through, for example, control of a smart plugload terminal, control of a smart switch, or control of smart lamp (e.g., smart bulbs). Further, the quality of the lighting, such as a dim value or a color temperature of the light, can be set by room controller (e.g., according to a user input). It is further conceivable that other devices can be controlled to assume an occupied state, such as a smart television turning on, motorized window treatments being directed to open. Each of these can be selected by the user (e.g., the hotel or the user) through the room controller or through an internet connection such as a browser or dedicated application.

The one or more devices can be directed to enter the first state through wireless command signals sent through various protocols such as BACnet IP, BACnet MS/TP, Modbus, Zigbee, Matter, DMX, WiFi, Bluetooth, etc In this manner, the room controller can act as an IoT hub, e.g., as a ZigBee Gate, or a BLE Central Control device.

At step 810, once the room is determined to be unoccupied, the room controller can adjust the climate control target temperature to a second value and direct the at least one device to enter a second state. The second value and the second state can be more energy efficient than the first value and the first state. What is more energy efficient can depend, at least in part, on the time of year. Thus, in the Summer months, the target temperature might be set higher to avoid using the air conditioning system, whereas in the Winter months, the target temperature might be set lower to avoid using the heating system. In certain examples, the target temperature can be depend on the temperature outside, and thus could be set according to an external thermometer. Likewise, the window treatments could be drawn close in the Summer or left open in the Winter to ensure that the room is not needlessly heated or cooled by the sunlight. Similarly, in the second state, the lighting devices within the room could be turned off or could be heavily dimmed to avoid consuming excess energy. While it is conceivable that the value of the unoccupied room could set according to a hotel guest, more likely this would be set by the hotel or as a default value.

While not depicted in FIG. 8, it should be understood that the flowchart of FIG. 8 is a repeated process. Thus, at the end of steps 808 or 810, the method returns to step 802 to monitor for the presence of a user.

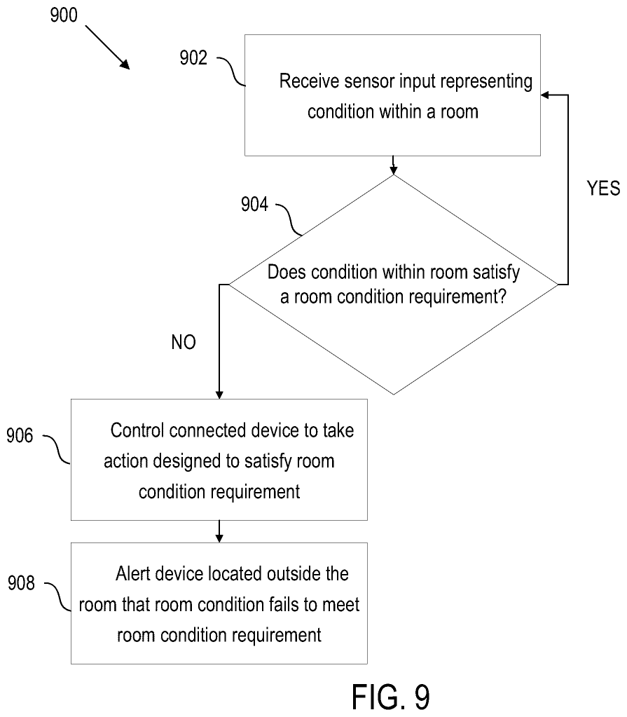

FIG. 9 depicts a flowchart of a method for determining a condition of a room, controlling one or more connected devices to adjust the room condition to maintain operational performance, including guest comfort and experience, and notification of remote devices of room conditions such that conditions can be attended to or for analytics, such as room reservation logic. In this example, the room controller functions to perform edge analysis locally. The edge analysis is used to control various devices within the room and to send processed information (rather than forwarding sensor signals) to remote devices for management purposes.

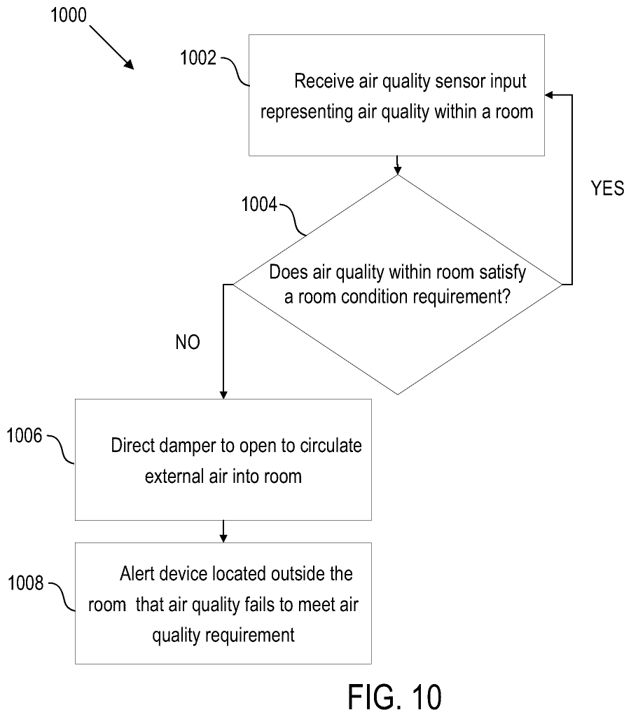

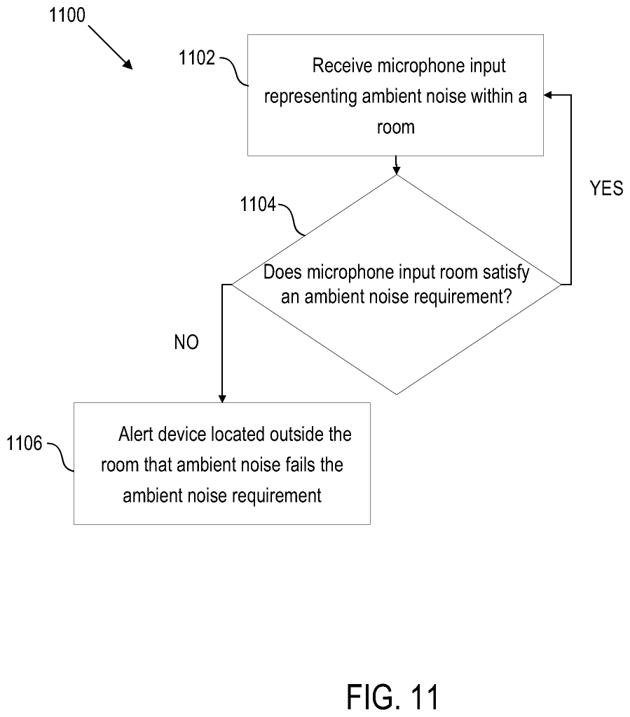

At step 902, a sensor input is received representing a condition within the room. As will be described in connection with FIGS. 10 and 11, the sensor can include sensors such as air quality sensors and microphones, although other sensors for determining a condition of a room are contemplated herein. Further, although a single sensor is mentioned at step 902, any number of sensor inputs respectively, representing conditions within a room, can be received. The sensors, from which the sensor inputs originate, are local to the room controller, typically located within the same room or located within the room controller itself. While, as described in connection with FIG. 8, the room controller can feature temperature and humidity sensors and can control a climate control system accordingly, for the purposes of method 900, the sensors for detecting conditions of a room are those besides temperature and humidity.

At step 904, the condition of the room represented by the sensor input is compared against a room condition requirement to determine if the room condition requirement is satisfied. Accordingly, the room controller can function as a rules engine, storing one or more rules or rulesets for determining whether required room conditions are met.

At step 906, upon determining that the condition within the room fails to satisfy the requirement, at least one connected device is controlled to take an action designed to satisfy the room condition requirement. The connected device can be connected to the room controller via a wired or a wireless connection (e.g., via Bluetooth, Zigbee, etc.), as appropriate. The action taken is designed to satisfy the room condition requirement. In other words, the action taken is some form of ameliorative action, designed to address whatever is causing the condition within the room to fail.

At step 908, upon determining that the condition within the room fails to satisfy the room condition requirement, an alert is sent to at least one device located outside the room that the room condition fails to meet the room condition requirement. Such a device can include, for example, a main distribution frame of a hotel or a remote server. For example, the alert can be sent to a local server running in a main distribution frame of a hotel, notifying it that the room condition has failed. The alert can, for example, be used to notify hotel staff of a condition that should be addressed. The alert can alternatively be used for a hotel room management system for the purposes of informing booking and reservations. In certain instances, rooms that fail to meet a room condition requirement can automatically be removed from reservable status until the condition is met. In other instances, the failure of a room condition requirement can generate tags for a particular room, such as “noisy,” which can be removed from reservable status for a particular guest, if the guest has requested a quiet room.

Steps 906 and 908 represent alternative responses to a failure of a room condition requirement. In certain instances, step 906 can be performed without step 908. Likewise, in certain instances (e.g., a shown in FIG. 11) step 908 can be performed without step 906. In other instances, step 908 can be performed only after step 906 has been performed and has failed to remedy the failed room condition requirement.

FIGS. 10 and 11 describe examples of method 900, respectively. Turning first to FIG. 10, there is shown a flowchart for comparing a detected air quality to an air quality room condition requirement, and taking the necessary steps in response. At step 1002, an input signal is received from an air quality sensor representing an air quality of the room. Such suitable air quality sensors include, for example, a tVOC and/or CO₂eq sensor. These sensors can be located within the room controller, or elsewhere within the room in a location suitable for measuring the air quality within the room.

At step 1004, the measured air quality can be compared to an air quality requirement to determine if the air quality requirement is satisfied. This step can include comparing the total volatile organic compounds, or comparing the greenhouse gases, to a threshold. It is, however, conceivable that other types of air quality sensors can be used to determine the quality of the air for the purposes an air quality requirement.

If the air quality falls below the threshold, then, in step 1006, a control signal can be sent to damper to open and circulate outside air into the room. The damper can remain open until the air quality increases above the threshold, or can remain open for some predetermined period of time. Other measures for improving the air quality, such as instructing an air purifier (e.g., including a HEPA air filter) to turn on or to increase fan speed, are contemplated.

At step 1008, an alert is sent to a device located outside of the room if the air quality falls below the threshold. As described in connection with the corollary step 908, a device outside of the room can be notified that the air quality of the room has failed to meet the room condition requirement. Such a device can be the main distribution frame of a hotel or a remote server. The alert can be forwarded or otherwise received by hotel staff so that air quality problem can be addressed, as necessary. The alert can also tag the room for the purposes of a hotel room management system, which can then automatically remove the room from reservable status, or can flag the room for staff before reserving the room for a guest. (For the purposes of this disclosure, a hotel room management system is any system that includes software for managing hotel rooms, including booking, is accomplished.) Further, in certain examples, the alert can be sent only after step 1006 failed to address the air quality requirement.

Turning next to FIG. 11, there is shown a flowchart for comparing a detected ambient noise to an ambient noise room condition requirement and taking the necessary steps in response. At step 1102, an input signal from a microphone is received representing ambient noise within a room. The microphone can be located within the room controller or located elsewhere within the room.

At step 1104, the microphone input is compared to an ambient noise requirement to determine if the ambient noise requirement is satisfied. This step can include comparing the microphone signal to a predetermined criterion. The predetermined criterion can be, in less complex examples, a magnitude of ambient noise, measured, for example, in decibels. For these instances, as described below, a user, such as a front desk, could be alerted. However, in certain examples, large noises could exceed a threshold but do not merit such an alert. For example, a noisy air conditioner could exceed the threshold, but not merit an alert to the front desk. To avoid false positive detections, in more complex examples, the predetermined criterion can be, for example, a prestored acoustic signal, such as the average sound of an air conditioner or the sound of a gunshot. Thus, by comparing the input microphone signal, noises that which do not merit alerting a user (i.e., those that do not fail the ambient noise requirement) can be discriminated from noises that do (i.e., those that do fail the ambient noise requirement).

At step 1106, an alert is sent to a device located outside of the room if the ambient noise fails the ambient noise requirement. Such a device can be the main distribution frame of a hotel or a remote server. The alert can be forwarded or otherwise received by hotel staff so that the noise problem can be addressed, as necessary. The alert can also tag the room for the purposes of a hotel room management system, which can then automatically remove the room from reservable status, or can flag the room for staff before reserving the room for a guest. If the noise relates to guest safety and requires the attention of emergency services, in certain examples, the device located outside of the room can be a server or other device for automatically alerting emergency services.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto; inventive embodiments may be practiced otherwise than as specifically described and claimed.

All references, including publications, patent applications, and patents, cited herein are hereby incorporated by reference to the same extent as if each reference were individually and specifically indicated to be incorporated by reference and were set forth in its entirety herein.

All definitions, as defined and used herein, should be understood to control over dictionary definitions, definitions in documents incorporated by reference, and/or ordinary meanings of the defined terms.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. A room controller for providing local control of conditions within a room, comprising:
a housing;
a controller disposed within the housing, and comprising at least one non-transitory storage medium storing program code, the program code comprising a plurality of room condition requirements, the controller being configured to:
receive a plurality of sensor inputs, each sensor input being representative of a condition within the room, each sensor input being respectively received from one of a plurality of sensors disposed locally with respect to the room controller;
determine, from at least one of the plurality of sensor inputs, whether a condition within the room fails to satisfy at least one of the plurality of room condition requirements; and
upon determining that the condition within the room fails to satisfy the requirement, performing at least one of:
controlling at least one connected device to take an action designed to satisfy the room condition requirement, or
sending an alert to at least one device located outside of the room that the room condition fails to meet the room condition requirement.

2. The room controller of claim 1, the room controller further comprising a temperature sensor disposed within the housing, the temperature sensor outputting a temperature sensor signal representative of an ambient temperature within the room, wherein the room controller is further configured to control a climate control system according to a target temperature and the temperature sensor signal such that the climate control system maintains the ambient temperature substantially at the target temperature.

3. The room controller of claim 1, wherein the sending an alert to at least one device located outside of the room that the room condition fails to meet the room condition requirement occurs upon determining that controlling the at least one connected device to take the action fails to satisfy the room condition.

4. The room controller of claim 1, wherein sending the alert to at least one device located outside the room comprising sending an alert to a hotel room management system.

5. The room controller of claim 1, wherein one of the plurality of sensor inputs is an input from an air quality sensor representing an air quality of the room, wherein one of the plurality of room condition requirements is an air quality requirement such that the controller is configured to determine whether the air quality of the room satisfies the air quality requirement as one of the plurality of room condition requirements.

6. The room controller of claim 5, wherein determining whether the air quality of the room satisfies the air quality requirement comprises comparing the air quality represented by the air quality input to a threshold.

7. The room controller of claim 5, wherein, for the air quality requirement, controlling at least one connected device to take an action designed to satisfy the room condition requirement comprises sending a control signal to a damper to circulate external air within the room.

8. The room controller of claim 5, wherein, for the air quality requirement, sending an alert to at least one device located outside of the room comprises sending an alert to a hotel room management system that the air quality of the room fails to satisfy the air quality requirement.

9. The room controller of claim 1, wherein one of the plurality of sensor inputs is an input from a microphone representing an ambient noise within the room, wherein one of the plurality of room condition requirements is an ambient noise requirement such that the controller is configured to determine whether the ambient noise of the room satisfies the ambient noise requirement as one of the plurality of room condition requirements.

10. The room controller of claim 9, wherein determining whether the ambient noise of the room satisfies the ambient noise requirement comprises comparing the ambient noise represented by the microphone input to a threshold.

11. The room controller of claim 9, wherein determining whether the ambient noise of the room satisfies the ambient noise requirement comprises comparing the ambient noise represented by the microphone to one of a plurality of stored signals to determine whether the ambient noise matches one of the stored signals.

12. The room controller of claim 9, wherein, for the ambient noise requirement, sending an alert to at least one device located outside of the room comprises sending an alert to a hotel room management system that the ambient noise fails to satisfy the ambient noise requirement.

13. The room controller of claim 1, wherein the controller is further configured to provide a beacon signal, via the antenna, such that a nearby antenna-equipped device can locate itself relative to the beacon signal.
